(19) United States
(12) Patent Application Publication
(10) Pub. No.: US 2007/0145708 A1
(43) Pub. Date: Jun. 28, 2007

(54) Arm and leg powered vehicle and head-mounted steering system therefor

(76) Inventor: John R. Davioni, Cayucos, CA (US)

Correspondence Address: LITMAN LAW OFFICES, LTD., P.O. BOX 15035, CRYSTAL CITY STATION, ARLINGTON, VA, 22215, US

(21) Appl. No.: 11/601,644

(22) Filed: Nov. 20, 2006

Related U.S. Application Data
(60) Provisional application No. 60/738,995, filed on Nov. 23, 2005.

(51) Int. Cl. B62M 1/00

(52) U.S. Cl. 280/233

(57) ABSTRACT

The arm and leg powered vehicle and head-mounted steering system therefor is a bicycle or similar vehicle, which is powered by the user through rotational actuation of both foot pedals and a hand-actuated crank, both of which provide rotational drive for the vehicle. The steering system for the vehicle includes a helmet-mounted steering mechanism, which translates rotational movement of the user's head and helmet into steering control for the vehicle, allowing the user to steer the vehicle only with the user's head and neck, leaving the user's hands free to power the vehicle. The helmet-mounted steering mechanism can be selectively disengaged, allowing the user to control the vehicle in a conventional manner.

### CROSS-REFERENCE TO RELATED APPLICATION

This application claims the benefit of U.S. Provisional Patent Application Ser. No. 60/738,995, filed Nov. 23, 2005.

### BACKGROUND OF THE INVENTION

1. Field of the Invention

The present invention relates to manually powered vehicles, bicycles and exercise devices, and more particularly to an arm and leg powered vehicle and a head-mounted steering system therefor. Particularly, a vehicle, such as a bicycle, is either provided with, or retrofitted to include, both foot pedals and a hand-operated crank for powering the vehicle, and a helmet-mounted steering system is provided, allowing the user to steer the vehicle through movement of the user's head alone.

2. Description of the Related Art

Arm and leg powered bicycles have been utilized for providing both upper body and lower body exercise to users. Such bicycles typically include a conventional foot pedal drive system coupled with a hand crank, providing hand-driven power as well. Typically, the foot pedals and the hand crank are coupled, thus requiring the user to use both feet and hands to power the bike. Such systems, however, are not easily adapted to paraplegics, who may not have use of their legs, or others who may simply wish to use the hand crank drive system on its own.

Further, such systems require a separate head-mounted steering system, since a conventional bicycle is steered through the use of pivoting handlebars, which cannot be easily reached and operated in a hand-crank type system. Head-mounted steering systems, allowing the user to control steering through rotation of the user's head, typically include a mechanical linkage directly from the user's head to the pivoting front wheel of the bicycle. Such systems, however, interfere with the user's vision and are not easily disengaged from the user's head, which may cause severe injury to the user in the case of an accident or other emergency.

Thus, an arm and leg powered vehicle and head-mounted steering system therefor solving the aforementioned problems is desired.

### SUMMARY OF THE INVENTION

The arm and leg powered vehicle and head-mounted steering system therefor is a bicycle, or similar vehicle, which is powered by the user through rotational actuation of both foot pedals and a hand-actuated crank, both of which provide rotational drive for the vehicle. The vehicle further includes a helmet-mounted steering mechanism, allowing the user to steer the vehicle through rotation of the user's head when the user's hands are operating the hand-actuated crank. The vehicle may be manufactured with an arm and leg powered drive system and helmet-mounted steering mechanism, or a conventional vehicle may be retrofitted with the additional drive and head-mounted steering systems, post-manufacture.

The head-mounted steering system for the vehicle includes a helmet-mounted steering mechanism, which translates rotational movement of the user's head and helmet into steering control for the vehicle, allowing the user to steer the vehicle only with the user's head and neck, leaving the user's hands free to power the vehicle. A torque transfer case is mounted on the vehicle, positioned behind the user's seat. The torque transfer case includes a rotating disc, which is driven to rotate by rotation of the user's head, which is mechanically translated by a drive shaft or through cables connected to both the rotating disc and the user's helmet. The rotating disc is further connected to the vehicle head-mounted steering system by a pair of cables, allowing rotation of the rotating disc to control the vehicle's steering.

The helmet-mounted steering mechanism can be selectively disengaged, allowing the user to control the vehicle in a conventional manner. Further, the user may selectively choose whether to power the vehicle through foot power, hand power, or the combination of the two.

These and other features of the present invention will become readily apparent upon further review of the following specification and drawings.

### BRIEF DESCRIPTION OF THE DRAWINGS

FIG. 1 is an environmental, perspective view of an arm and leg powered vehicle and head-mounted steering system therefor according to the present invention.

FIG. 2 is a partial top view of the arm and leg powered vehicle and head-mounted steering system therefor according to the present invention.

FIG. 3 is a partial top view of the torque transfer case and steering linkage of the arm and leg powered vehicle and head-mounted steering system therefor according to the present invention.

FIG. 4 is a partial side view of the head-mounted steering system of the arm and leg powered vehicle and head-mounted steering system therefor according to the present invention.

FIG. 5 is a partial side view of an alternative embodiment of the head-mounted steering system of the arm and leg powered vehicle and head-mounted steering system therefor according to the present invention.

FIG. 6 is a partial side view of another alternative embodiment of the head-mounted steering system of the arm and leg powered vehicle and head-mounted steering system therefor according to the present invention.

Similar reference characters denote corresponding features consistently throughout the attached drawings.

### DETAILED DESCRIPTION OF THE PREFERRED EMBODIMENTS

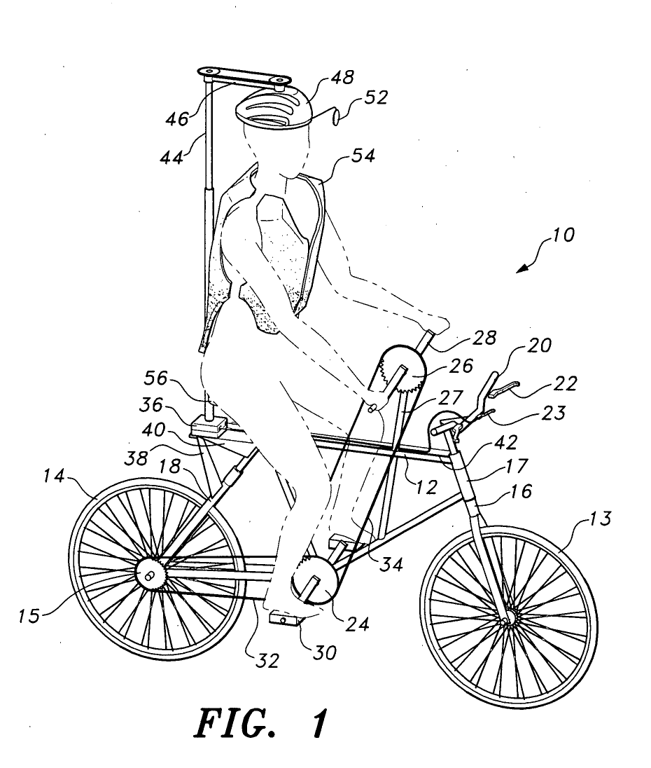

FIG. 1 illustrates an arm and leg powered vehicle and a head-mounted steering system therefor, designated generally as 10 in the drawings. Although shown in the drawings as being adapted for a bicycle, it should be understood that the arm and leg powered drive system, and the associated head-mounted steering system, may be adapted to a wide variety of vehicles, as will be described in further detail below. As shown in the drawings, the exemplary bicycle is similar to a conventional bicycle with an added hand-driven drive system and a helmet-mounted steering system (both to be described in greater detail below). The bicycle may either be manufactured with the drive and head-mounted steering systems, or a conventional bicycle may be retrofitted with additional drive and head-mounted steering systems according to the present invention.

The exemplary bicycle illustrated in FIG. 1 includes a main bicycle frame 12, which includes a conventional rear wheel mount 18, a front wheel mount 16 and front wheel mounting tube 17. The upper end of the front wheel mount 16 is rotatably received within mounting tube 17, allowing front wheel 13 to be rotated and steered by the user. A conventional rear wheel 14 is mounted on the lower end of rear wheel mount 18. The vehicle 10 further includes conventional bicycle handlebars 20, along with brake and clutch levers 22, 23, respectively.

Conventional bicycle foot pedals 30 drive rotation of foot pedal gear or sprocket 24. In addition to the foot-operated drive system, vehicle 10 also includes a hand-operated crank 28, which drives rotation of hand crank gear or sprocket 26. Hand crank gear or sprocket 26 is rotatably mounted on the upper end of vertical mounting rod 27, and is linked to foot pedal gear or sprocket 24 by drive chain 34. Vertical mounting rod 27 may be vertically adjustable in length, allowing users of varying height to utilize the hand crank 28. Foot pedal gear or sprocket 24 is, in turn, linked to rear wheel gear or sprocket 15 by drive chain 32, thus providing hand and foot powered rotational drive to rear wheel 14.

The addition of hand crank 28 to the conventional bicycle drive system allows the user to exercise his or her arms in addition to the conventional leg exercise gained by bicycle riding. Further, the user may selectively power the vehicle 10 through either hand power or foot power, allowing the user to choose upper body or lower body exercise, and further allowing a disabled user to power the vehicle with his or her hands alone. The user may selectively remove drive chain 34 if the user wishes to use the vehicle as a conventional foot-driven bicycle.

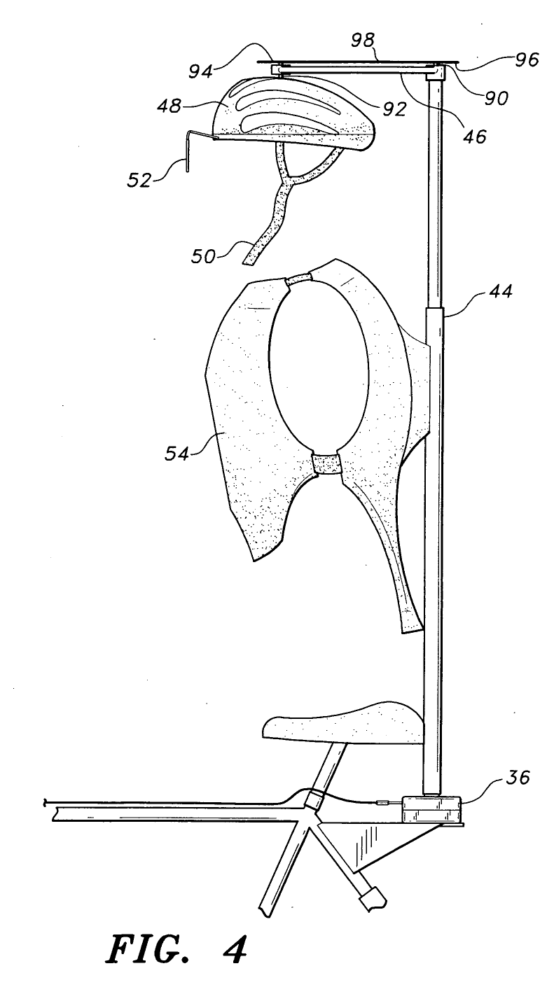

If the user utilizes the hand crank 28, the user will be unable to steer vehicle 10 in the conventional manner; i.e., through use of handlebars 20. Thus, a helmet-mounted steering system is further provided, allowing the user to steer vehicle 10 through rotation of his or her head alone. System 10 is further provided with bicycle helmet 48, which is worn on the head of the user. Helmet 48 may be of conventional design and may include an attached safety mirror 52. Helmet 48 is secured to a front end of helmet mount 46, the rear end of which is mounted on the upper end of a telescoping tube 44. As will be described in greater detail below, rotation, of the user's head is translated into rotation of a vertical shaft positioned within telescoping tube 44 (shown in FIG. 4), which, in turn, drives rotation of front wheel mount 16. Telescoping tube 44 is adjustable in length, allowing the system to be adapted for use by users of varying heights.

System 10 further includes a safety vest 54, which is fixed to telescoping tube 44. When the user is seated on bicycle seat 56, the vest maintains the user in position to operate the helmet-mounted steering system. The lower end of telescoping tube 44 is mounted on torque transfer case 36, which is positioned behind seat 56, and is supported by a pair of supports 38, 40. The positioning of the torque transfer case 36 and the telescoping tube 44 behind the user provides a head-mounted steering system, which will not interfere with the user's forward vision and, further, in the case of accident or emergency, will not cause additional or undue injury to the user. It should be understood that the various elements of the system, such as supports 38, 40, may have any desired dimension and configuration.

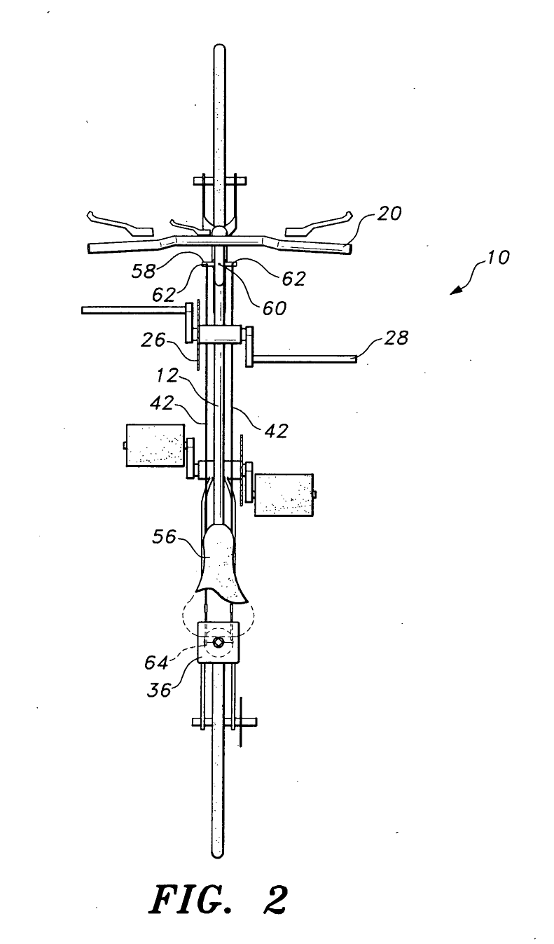

As best shown in FIG. 2, the torque transfer case 36 includes a rotating disc 64, rotatably mounted on an upper surface thereof. A pair of cables 42 are provided, with each cable 42 having a rear end and a front end. The rear ends of cables 42 are secured to the rotating disc 64 and the front ends of the cables 42 are secured to a pivotal member 58. As shown, the front ends of cables 42 are secured to the pivotal member 58 by bolts 62 or the like, and the pivotal member 58 pivots centrally about a pivot pin 60. Pivotal member 58 is mounted on the upper end of front wheel mount 16. Thus, rotation of pivotal member 58 drives rotation of front wheel mount 16, allowing the user to steer the vehicle through rotation of rotating disc 64. Further, it should be noted in FIG. 2 that the handlebars of the hand crank 28 have a width between end points of approximately shoulder-width for the user. The handlebars should have a width wide enough to allow the user to operate the hand crank 28 without interference from the up-and-down motion of the user's legs and knees.

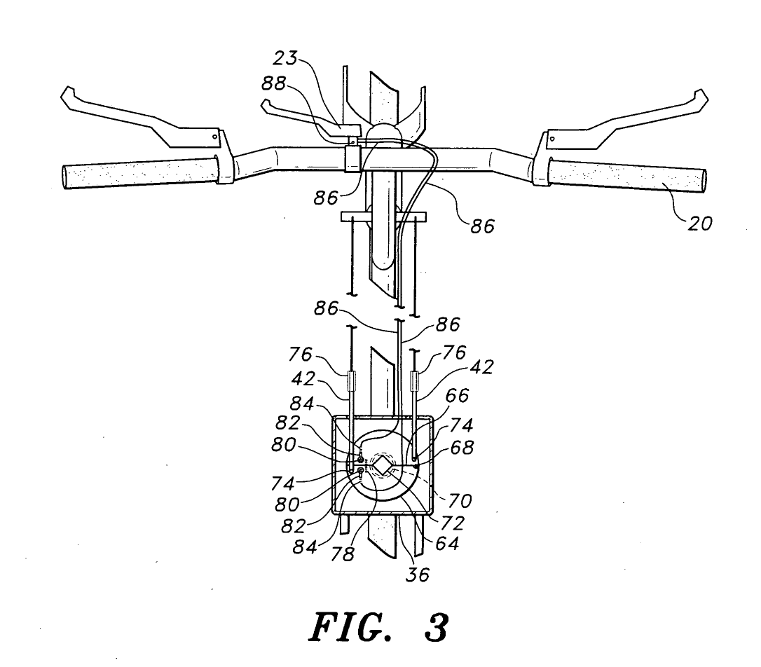

The torque transfer case 36 is best shown in FIG. 3. As shown, rotating disc 64 has a substantially circular contour, and is divided into a pair of semicircular members at division 66. The semicircular members are pivotally joined by a hinge 68 and, as shown, the rear ends of cables 42 are each respectively attached to one of the semicircular members. Each cable 42 further includes an adjustment turnbuckle 76, allowing the user to adjust the length of each cable 42.

A pair of brackets 82 are provided, and each bracket is joined to a respective one of the semicircular members adjacent the division 66 by a hinge 80. Each bracket 82 has a spring 84 secured thereto and projecting outwardly therefrom. A pair of clutch cables 86 are provided, each having a front end and a rear end, with each rear end being secured to the opposed second end of a respective one of springs 84, as shown.

The front ends of clutch cables 86 are attached to clutch lever 23, so that actuation of clutch lever 23 by the user will result in opposed forces acting on each semicircular member, causing the semicircular members to rotate in opposite directions about hinge 68. The range of rotational motion about hinge 68 is limited by spring 78, which has a pair of opposed ends, each mounted on a respective semicircular member, as shown.

It should be understood that the contouring of torque transfer case 36 is dependent upon the particular needs and desires of the user. Although shown as having a substantially rectangular contour, the torque transfer case 36 may have a circular contour, for example, or any other desired dimension and configuration. Further, the positioning of elements, such as the spring 78, may be arranged as desired. For example, rather than positioning spring member 78 on the upper surface of rotating disc 64, the spring element 78 may be positioned along a peripheral side edge thereof.

Rotating shaft 90 is received within telescopic tube 44 (as shown in FIG. 4), with the upper end of rotating shaft 90 being rotationally driven by movement of the user's helmet, and the lower end being received in socket 72, shown in FIG. 3. The positioning of the lower end of telescopic tube 44 on the rotating disc 64 is shown by dashed lines 70. When the lower end of rotating shaft 90 is received within socket 72, formed in rotating disc 64, the rotation of rotating shaft 90 drives rotation of disc 64 which, in turn, drives rotation of member 58 about pivot pin 60, via the tension in cables 42.

When the user actuates clutch lever 23, the pair of semicircular members forming rotating disc 64 are separated from one another, rotating about hinge 68, which disengages rotating disc 64 from the rotating shaft 90. Thus, when the clutch 23 is engaged, the head-mounted steering system is disengaged, and the vehicle can be steered through conventional handlebars 20. A locking pin 88 is provided, allowing the user to maintain the clutch 23 in the engaged position, allowing the user selection of either the helmet-mounted steering system or the conventional steering system.

As shown in FIG. 4, helmet 48 has a helmet axle 92 projecting upwardly therefrom. Helmet 48 is a conventional bicycle helmet, having a chinstrap 50 and an optional safety mirror 52 attached thereto. Helmet mount 46 has a rear end, which is mounted to the upper end of telescoping tube 44, and a front end, through which helmet axle 92 projects. Helmet axle 92 is free to rotate within the front end of helmet mount 46.

A first gear 94 is mounted on the upper end of helmet axle 92 and is driven to rotate by rotation of helmet 48 and subsequent rotation of helmet axle 92. A second gear 96 is mounted on the upper end of rotating shaft 90, and first gear 94 is linked to second gear 96 by drive chain 98. Thus, rotation of helmet 48 drives gear 96 to rotate, which, in turn, drives rotating shaft 90 to rotate under user control, allowing the user to steer the vehicle through rotation of his or her head.

As further shown in FIG. 4, safety vest 54 is joined to telescoping tube 44, which aids in maintaining the user in position with respect to helmet 48 and helmet mount 46. The telescoping tube 44 may be sewn into the vest 54, which aids in maintaining the telescoping tube 44 in proper position with respect to the torque transfer case 36, and further aids in positioning the user with respect to the helmet and head-mounted steering system, and provides additional stability for helmet mount 46.

Further, as an added safety measure, helmet 48 can be easily removed from helmet mount 46, allowing the user to easily disengage from the vehicle in the case of an accident. Helmet axle 92 may be provided with a breakaway connection to the front end of helmet mount 46, allowing the user to quickly and easily disengage from the helmet mount 46 in the case of an accident.

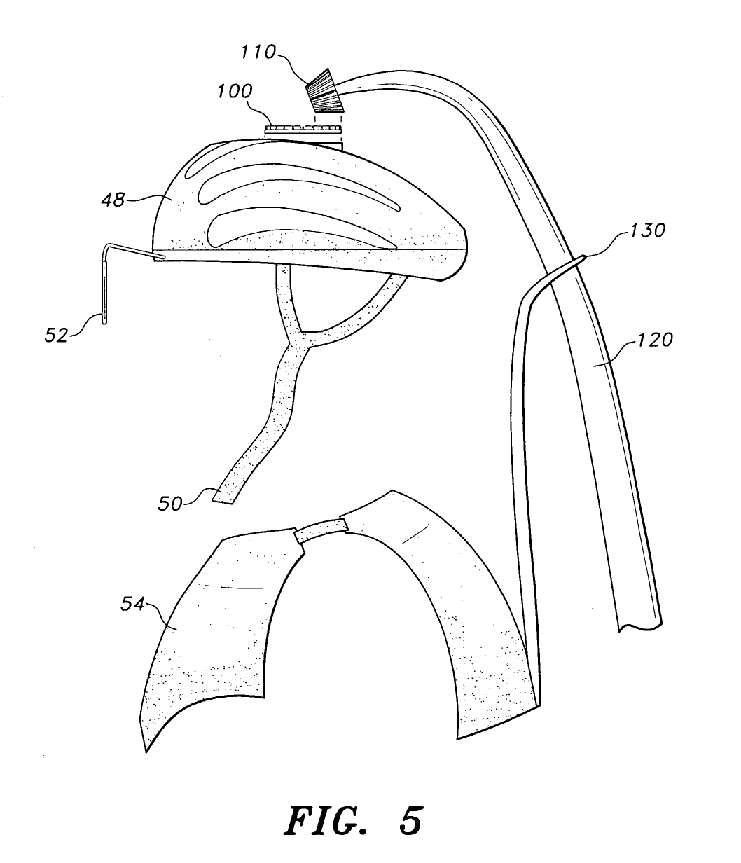

In the alternative embodiment of FIG. 5, the telescoping tube 44 of FIG. 4 is replaced with a back plate 130, joined to the back of vest 54. The back plate has an opening formed through the upper end, through which extends a flexible rotating rod 120. The flexible rotating rod 120 is formed from a flexible metal and is adjustable with respect to back plate 130 and the torque transfer case 36. Formed at the upper end of the flexible rotating rod 120 is a pinion gear 110, which engages a ring gear 100, mounted on the upper surface of helmet 48. Rotation of the user's head and helmet 48 causes the ring gear 100 to rotate which, in turn, causes pinion gear 110 to rotate, translating the rotation of the user's head into rotation of the flexible rotating shaft 120. Back plate 130 maintains the connection between pinion gear 110 and ring gear 100.

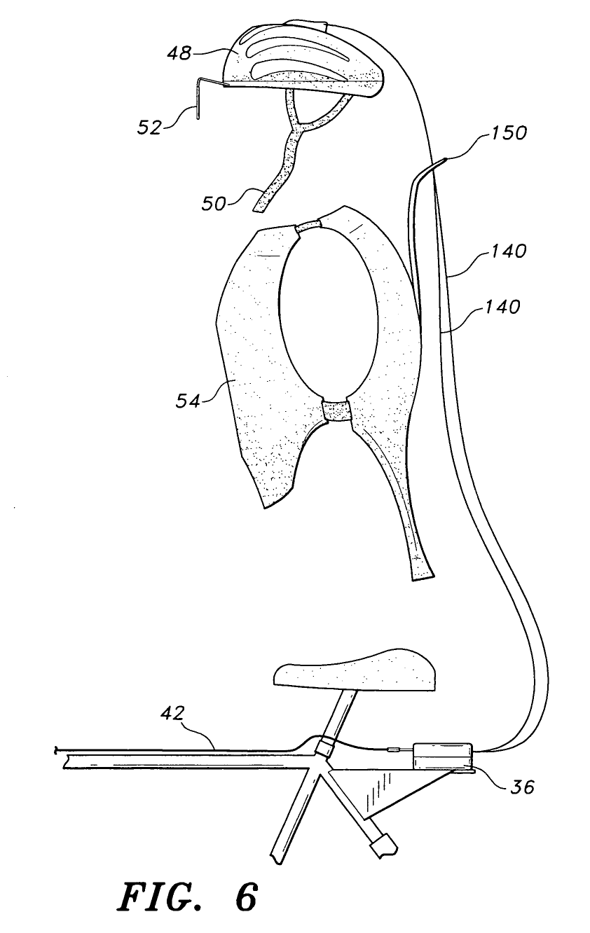

In the alternative embodiment of FIG. 6, the back plate 130 of the embodiment of FIG. 5 is replaced with a rigid plate 150, which may be formed from a plastic material. Rather than utilizing a rotating shaft, as in the embodiments shown in FIGS. 4 and 5, the embodiment of FIG. 6 utilizes a pair of cables 140. Upper ends of cables 140 are fixed to the helmet 48 and are positioned, under tension, by an opening through rigid plate 150. The lower ends of cables 140 are fixed directly to the rotating disc 64 of the torque transfer case 36. Thus, rotation of the user's head and helmet 48 is transferred to the rotating disc 64 through cables 140, allowing the user to steer the vehicle through movement of his or her head.

Although shown in the drawings as being a bicycle, it should be understood that the head-mounted steering system and the arm and leg drive system may be applied to any suitable vehicle. For example, a four-wheel vehicle, operated in a similar manner to a bicycle, may be adapted for head-mounted steering and arm-driven power, as described above. Alternatively, a boat may utilize the above system, with the arm and leg power systems driving the boat's propeller and the helmet-mounted steering system driving rotation of the boat's rudder.

It is to be understood that the present invention is not limited to the embodiments described above, but encompasses any and all embodiments within the scope of the following claims.

I claim:

1. An arm and leg powered bicycle and head-mounted steering system therefor, comprising:
a main bicycle frame having front and rear ends, a front mounting tube being formed on the front end;
a rear wheel pivotally mounted to the rear end of the main bicycle frame;
a front wheel mount having an upper end and a lower end, the upper end being rotatably received within the front mounting tube;
a front wheel pivotally mounted to the lower end of the front wheel mount;
a vertical mounting rod projecting upwardly from the main bicycle frame;
a first sprocket rotatably mounted to an upper end of the vertical mounting rod;
a second sprocket rotatably mounted to a lower end of the main bicycle frame;
a hand-operated crank mounted centrally on the first sprocket;
a foot-operated crank mounted centrally on the second sprocket;
a first drive chain mechanically linking the first sprocket with the second sprocket;
a second drive chain mechanically linking the second sprocket with the rear wheel;
a bicycle seat mounted on the main bicycle frame;
a torque transfer case mounted on the main bicycle frame, the transfer case being positioned on the rear end of the main bicycle frame, adjacent the bicycle seat;
a rotating disc rotatably mounted on an upper surface of the torque transfer case;
a bicycle helmet for protecting the head of a user;
helmet-mounted steering means for steering the front wheel through rotation of the bicycle helmet and the user's head, the helmet-mounted steering means having an upper end and a lower end, the upper end of the helmet-mounted steering means being secured to an upper surface of the bicycle helmet, the lower end of the helmet-mounted steering means being secured to the rotating disc, whereby rotation of the bicycle helmet imparts corresponding rotation to the rotating disc;
a pivotal steering mount pivotally mounted to the front end of the main bicycle frame, the pivotal steering mount being in communication with the upper end of the front wheel mount; and
first and second cables, each of the cables having a front end and a rear end, the front ends being secured to the pivotal steering mount, the rear ends being secured to respective substantially diametrically opposed points on the periphery of the rotating disc, whereby rotation of the user's head and the bicycle helmet imparts rotation to the rotating disc through the helmet-mounted steering means, the subsequent rotation of the rotating disc imparting a corresponding rotation of the pivotal steering mount, allowing the user selective steering and control of the front wheel.

2. The arm and leg powered bicycle and head-mounted steering system therefor as recited in claim 1, further comprising:
a hand-operated clutch lever pivotally mounted on the front end of said main bicycle frame; and
a clutch cable having a front end and a rear end, the front end of the clutch cable being attached to the hand-operated clutch lever, the rear end of the clutch cable being secured to said rotating disc, whereby actuation of the hand-operated clutch lever disengages said rotating disc from said helmet-mounted steering means.

3. The arm and leg powered bicycle and head-mounted steering system therefor as recited in claim 2, wherein said rotating disc is formed from first and second semicircularly contoured portions and a hinge, the first and second semicircularly contoured portions being pivotally secured to one another by the hinge, said clutch cable being secured to the first semicircularly contoured portion, whereby actuation of said hand-operated clutch lever separates the first and second semicircularly contoured portions from one another.

4. The arm and leg powered bicycle and head-mounted steering system therefor as recited in claim 3, wherein said helmet-mounted steering means comprises:
a rotating shaft having an upper end a lower end, the lower end being releasably joined to said rotating disc;
a first steering gear mounted to the upper surface of said bicycle helmet;
a second steering gear mounted to the upper end of the rotating shaft; and
a third drive chain linking the first and second steering gears, whereby rotation of said bicycle helmet drives rotation of the second steering gear and the rotating shaft.

5. The arm and leg powered bicycle and head-mounted steering system therefor as recited in claim 4, further comprising a telescoping rod mounted to said torque transfer case and projecting upwardly therefrom, the rotating shaft being received within the telescoping rod.

6. The arm and leg powered bicycle and head-mounted steering system therefor as recited in claim 5, further comprising a garment secured to the telescoping rod.

7. The arm and leg powered bicycle and head-mounted steering system therefor as recited in claim 3, wherein said helmet-mounted steering means comprises:
a garment having a back portion adapted for placement adjacent the back of the user; and
a back plate mounted to the back portion and projecting substantially upwardly therefrom, the back plate having an upper portion having an opening formed therethrough.

8. The arm and leg powered bicycle and head-mounted steering system therefor as recited in claim 7, wherein said helmet-mounted steering means further comprises:
a ring gear mounted on the upper surface of said bicycle helmet; and
a flexible rod having an upper end and a lower end, the flexible rod being received through the opening formed through the upper portion of the back plate, the lower end of the flexible rod being releasably joined to said rotating disc, the upper end of the flexible rod forming a pinion gear, the pinion gear engaging the ring gear, whereby rotation of the bicycle helmet drives rotation of the pinion gear and the flexible rod.

9. The arm and leg powered bicycle and head-mounted steering system therefor as recited in claim 7, wherein said helmet-mounted steering means further comprises:
at least one steering cable having an upper end and a lower end, the at least one steering cable being received by the opening formed through the upper portion of the back plate, the upper end of the at least one steering cable being secured to the upper surface of the bicycle helmet, the lower end of the at least one steering cable being secured to said rotating disc.

10. The arm and leg powered bicycle and head-mounted steering system therefor as recited in claim 3, further comprising a spring joining the first and second semicircularly contoured portions.

11. The arm and leg powered bicycle and head-mounted steering system therefor as recited in claim 3, further comprising a second clutch cable having a front end and a rear end, the front end being secured to said hand-operated clutch lever, the rear end being secured to said second semicircularly contoured portion.

12. The arm and leg powered bicycle and head-mounted steering system therefor as recited in claim 11, further comprising first and second springs secured to the first and second clutch cables, respectively, the first and second springs joining the first and second clutch cables to the first and second semicircularly contoured portions, respectively.

13. The arm and leg powered bicycle and head-mounted steering system therefor as recited in claim 1, wherein said first and second cables each have an adjustable length.

14. The arm and leg powered bicycle and head-mounted steering system therefor as recited in claim 5, further comprising a horizontal support member having opposed first and second ends, the first end being mounted on an upper end of the telescoping rod, the second end being mounted on the upper surface of said bicycle helmet.

15. A head-mounted steering system for a vehicle, comprising:
rotational means for steering having an upper end and a lower end;
a helmet adapted to be worn by a user, the upper end of the means for steering being attached to the helmet, the rotational means for steering being adapted for mounting on the vehicle behind the user; and
torsional transfer means for translating rotation of the lower end of the rotational means for steering into steering rotation of at least one wheel of the vehicle, whereby user-controlled rotation of the helmet controls and drives the steering rotation.

16. The head-mounted steering system for a vehicle as recited in claim 15, further comprising:
a hand-operated clutch lever adapted for being pivotally mounted on the vehicle; and
a clutch cable having a front end and a rear end, the front end of the clutch cable being attached to the hand-operated clutch lever, the rear end of the clutch cable being secured to said torsional transfer means, whereby actuation of the hand-operated clutch lever disengages said torsional transfer means from said rotational means for steering.
